(19) United States
(12) Patent Application Publication
(10) Pub. No.: US 2005/0168135 A1
(43) Pub. Date: Aug. 4, 2005

(54) Luminescence display apparatus and method for fabricating the same

(75) Inventor: Daisuke Iga, Tokyo (JP)

Correspondence Address: OSTROLENK FABER GERB & SOFFEN, 1180 AVENUE OF THE AMERICAS, NEW YORK, NY, 100368403, US

(73) Assignee: NEC Corporation

(21) Appl. No.: 11/013,953

(22) Filed: Dec. 16, 2004

(30) Foreign Application Priority Data
Dec. 16, 2003 (JP) 2003-418320

(51) Int. Cl. H01J 1/62

(52) U.S. Cl. 313/500

(57) ABSTRACT

A luminescence display apparatus including a light blocking structure having a function of reflecting light propagating through the dielectric layer and/or of attenuating light propagating through the dielectric layer, that surrounds a EL element for separating a pixel driving TFT from the EL element. Self-emitted light or external light be attenuated before reaching the TFT by using the light blocking structure to reduce the photo leakage of the TFT to provide the active matrix organic EL display apparatus having the less defects and the excellent gradation controllability.

### TECHNICAL FIELD

The present invention relates to a luminescence display apparatus, and more specifically, to an active matrix organic electro-luminescence (EL) display apparatus including an organic EL section and a driving circuit including an array of thin film transistors (TFTs). The present invention also relates to and a method of fabricating the same.

### BACKGROUND ART

An organic EL device is a self luminescent device which utilizes the principle that a fluorescent material emits light by using the energy obtained by combination between positive holes injected from a cathode and electrons injected from an anode upon applying an electric field thereon. In these days, the organic EL device attracts attention as a display apparatus in place of CRT and LCD because of a wider viewing angle and an excellent response characteristic. Among the organic EL devices, an active matrix organic EL device attracts special attention in which organic EL devices arranged in matrix are driven by using TFTs.

An active matrix organic EL display apparatus consists of by unit pixels formed by EL organic devices and TFT active elements driving the organic EL devices, and a peripheral circuit formed by an active element driving the unit pixels and a passive element such as a capacitor and a resistor. Typical configurations are as shown in FIGS. 1a and 1b. In FIG. 1a, a display region 16 is formed on a substrate 1, and peripheral circuit regions 17 consisting of the TFT active elements are disposed on the same substrate 1 around the display region 16. In FIG. 1b, external driving circuits 34 formed by LSIs are connected to the substrate 1 through flexible substrates 36 around the display region 16.

The planar structure and the vertical section of the display region of the active matrix organic EL display apparatus will be described in detail referring to FIGS. 2 and 3, respectively. The EL display apparatus is an example in which the peripheral circuits are formed on the same substrate around the display region 16. The peripheral circuits may be disposed outside the substrate by using LSIs.

As shown in FIG. 2, a conventional active matrix organic EL display apparatus includes a plurality of gate lines 12 and data lines extending and crossed in orthogonal direction with each other, and pixels 25 are formed on each of the intersecting points.

The pixel 25 includes a pixel driving TFT 18 covered with a planerizing layer 6 for flattening irregularities generated due to the difference of the height of the respective elements. An aperture is formed through the planerizing layer 6 on the top surface of a cathode 5, and an EL element 19 is formed inside the border 20 with the planerizing layer 6. While one pixel driving TFT 18 is shown in FIG. 2, a plurality of the pixel driving TFTs 18 may be used depending on the drive system. The pixels 25 are laid out in the form of an array, forming up the display region 16, and the peripheral circuit regions 17 including driving circuits are formed on the outer periphery of the display region 16.

As shown in FIG. 3, the conventional active matrix organic EL display apparatus includes a TFT active layer 9 on the transparent substrate 1 such as glass, and the gate lines 12 are formed thereon through a gate oxide film 2. A first interlayer film 3 is formed to cover the gate lines 12, and the wiring 11 is formed on the first interlayer film 3. A wiring 11 is connected to the source/drain region of the TFT active layer 9 through a contact hole. A second interlayer film 4 is formed on the wiring 11, and the cathode 5 is formed on the second interlayer film 4. The cathode 5 is connected through a contact hole to the wiring 11 which is connected to the pixel driving TFT 18. The TFT substrate herein refers to a part which is above the substrate 1 and below the cathode 5 for the sake of simplicity.

The planerizing layer 6 is formed on the TFT substrate and an inner part of the display 16. The planerizing layer 6 absorbs the irregularities due to the respective components such as the step of the cathode 5 and the step generated on the pixel driving TFT 18 for preventing the disconnection deficiency between the EL organic layer 7 formed on the TFT substrate and an anode 8 and the short-circuit deficiency between the anode 8 and the cathode 5. No planerizing layer is formed on the peripheral circuit regions 17 because the EL organic layer 7 and the anode 8 are not formed.

An aperture is formed through the planerizing layer 6 on the top surface of the cathode 5, and then EL organic layer 7 is deposited to form a junction between said cathode 5 and said EL organic layer 7, and the cathode 8 is formed to provide the device 19. The EL organic layer 7 consists of a first hole-transporting layer, a second hole-transporting layer, a luminescence layer and an electron-transporting layer, and the anode 8 consists of a single layer structure made of silver-magnesium alloy or a two-layer structure such as aluminum+aluminum-lithium alloy and aluminum+lithium fluoride. The light generated at the EL element 19 is extracted to exterior through a light-extracting section 14 in the form of extracted light 13. As the result, images are displayed on the lower surface of the said glass substrate 1 shown in FIG. 3.

Then, a method of fabricating the conventional active matrix organic EL device will be described referring to FIG. 3. After a semiconductor layer is deposited on the transparent substrate 1 by using the CVD method, isolation is taken place to form the TFT active layer 9. After that, impurity ions are introduced by the ion implantation method to determine conduction type of the said TFT active layer 9 and the gate oxide film 2 is formed by using the CVD method on the said TFT active layer 9. A metal layer is then deposited by using the sputtering method and consequentially TFT is fabricated after gate line 12 is formed. The dry etching is generally used to form the gate line 12. The above method of fabricating the TFT is applicable for an amorphous silicon (hereinafter referred to as “a-Si”) TFT, thus an additional process for re-crystallizing the a-Si layer into polycrystalline silicon (hereinafter referred to as “p-Si”) layer by means of heat annealing or laser annealing is needed in case of polycrystalline silicon TFT being used.

After the TFT formation, the first interlayer film 3 is grown. Then, contact holes are formed at specified positions by using the dry etching. Then a metal layer is deposited by means of sputtering and the data lines 10 and wiring 11 are patterned by the dry etching. After the formation of the second interlayer film 4 on said data lines 10 and wiring 11 formation, a contact hole is perforated for connecting the cathode 5 with the wiring 11 by using the dry etching. After a transparent conductive layer acting as the cathode 5 is formed by using the sputtering, the cathode 5 is patterned by using the dry etching. In this manner, the fabrication of the TFT substrate is accomplished.

Upon the accomplishment of the TFT substrate, the planerizing layer 6 is deposited and an aperture is formed through the planerizing layer 6. Then, whole TFT substrate is annealed to perform the reflowing at the edge of said aperture. Successively, the organic EL layer 7 and the anode 8 are deposited and bring the active matrix organic EL display apparatus to completion. Examples of the active matrix organic EL display apparatus driven by the TFT are described in JP-A-2002-252088 (pages 4 to 5, FIG. 55) and JP-A-2002-231459 (page 5, FIG. 47).

Generally, the problem to be solved in the TFT-applied products is decrease of photo leakage current generated due to the photovoltaic effect. The photo leakage current induces malfunctioning of the circuit consisting of the TFT, and further, causes defects of pixels and the decrease of the contrast ratio of the applied products. Apparently, this problem similarly exists in the active matrix organic EL display devices to which this invention relates. Specifically for active matrix organic EL display devices, the major light source which may be a cause of the photo leakage current is external light source such as sunlight and environmental light, and internal light source or light self-emitted from the EL element 19.

The influence of the leakage current will be quantitatively described. The maximum current amount flowing in the pixel 25 of the active matrix organic EL display apparatus is generally about 50 nA to 150 nA depending on the factors such as required brightness, luminescence efficiency and aperture ratio of pixels of the display device. When the requirement of gray scale is assumed to be 64, the current is about 2 nA per one scale. In case of 256 gray scales, it is as low as about 0.5 nA. In contrast, the photo leakage current induced by external light is about 1 nA to 10 nA, and the leakage current due to the internal light from the EL element 19 is estimated to be 0.1 nA to 1 nA. Therefore, the influence of the leakage current becomes more predominant with the increase of the required gray scale.

A solution for shielding the TFT from the external light which has been applied to general liquid crystal display devices using the TFT for switching can also be applied to the active matrix organic EL display. Generally, a light blocking structure made of metal is added to the TFT substrate. For example, TFT with shield structure on its top and/or bottom, which effectively block external light sources are described in JP-A-9(1997)-80476, JP-A-11(1999)-84363 and JP-A-2000-164875.

In contrast to above, for the peripheral circuit regions 17, a sufficiently large shielding structure that covers entire said circuit regions 17 can be applied outside of the substrate because the peripheral circuit regions 17 themselves do not contribute to display any images.

The configuration shown in FIG. 4 is a structure having the light blocking structure against the external light source in which a bottom shielding layer 38 and an outside shielding structure 39 are added to the bottoms of the pixel-driving TFT 18 and outside of the peripheral circuit TFT regions 17, respectively, of the structure shown in FIG. 3.

On the other hand, for shielding self-emitted light, it must be noted that the self-emitted light in concern can reach the TFT from the lateral direction because the light source or the EL element 19 is laid out adjacent to the TFT. It also has to be noted that since the light emitted from the EL element 19 has no directivity and projected in all directions, thus some portion of the light can reach the TFT active layer 9 after being reflected at the interface between the interlayer films composing the TFT substrate. Especially, the portion projected at the interface with an incident angle larger than a critical angle primarily determined by the refraction coefficient of the interlayer films may reach the TFT active layer 9 after repeated reflections and traveling inside the TFT substrate.

FIG. 5 describes how the self-emitted light travels through the TFT substrate and eventually reaches the TFT. A mode in which light transmits laterally and reaches the TFT directly is shown by (a), modes in which light reaches the TFT with a single reflection are shown by (b) and (c), and modes in which light reaches the TFT with a plurality of reflections are shown by (d) and (e). More specifically, (b) shows the mode in which the reflection takes place on the interface between the first interlayer film 3 and the substrate 1, (c) shows the mode in which the reflection takes place on the bottom surface of the substrate, and (d) and (e) show the modes in which the reflections take place on the interface between the second interlayer film 4 and the first interlayer film 3 and on the interface between planerizing layer 6 and the second interlayer film 4. The difference between the modes (d) and (e) is the total distance the light travels through as schematically shown. FIG. 5 only schematically shows the path that light can take and in reality the modes (b) to (e) less likely exist independently. For example, (b) and (c) may transit to (d) and (e) and vice versa.

It is noted that the self-emitted light may reach the peripheral circuit TFT section 21 composing the peripheral circuit region 17 laid out around the display region 16 as well as the pixel driving TFT 9 adjacent to the EL element 19 after the plurality of the reflections described as the modes (b) to (e). Therefore, the countermeasure of shielding the self-emitted light is required in the peripheral circuit TFT section 21 included in the peripheral circuit region 17 formed outside of the display region 16 in addition to the pixel-driving TFT 18 adjacent to the EL element 19 in the active matrix organic EL display apparatus in which the peripheral circuit region 17 is formed on the same substrate having the display region 16.

With regard to the light directly traveling to the TFT in the mode (a) among the five modes, use of a colored planerizing insulation film (JP-A-2000-172198) and disposal of a light blocking structure for obstructing a light path between an EL layer and a TFT active element (JP-A-2000-172199) have been proposed. However, no shielding is provided on the side surface of the TFT so that the photo leakage generated by the light reaching the TFT after the reflection on the interface in the modes (b) to (e) cannot be efficiently prevented.

As the countermeasure against the light of the modes (b) to (e), a three-dimensional shielding structure surrounding the TFT active element or the EL device by utilizing a wiring material has been proposed (JP-A-2002-132186). As shown in FIG. 5, this structure provides the efficient shielding effect on the mode (b), but not on the modes (d) and (e) because no shield is formed in the second interlayer film 4.

### SUMMARY OF INVENTION

In view of the foregoing circumstance, an object of the present invention is to provide a luminescence display apparatus in which self-emitted light causing photo leakage in an TFT active element in an active matrix organic EL display apparatus can be shielded, and a method of fabricating the same.

Thus, the present invention provides, in a first aspect thereof, a luminescence display apparatus including a dielectric substrate, a plurality of interconnect lines extending in row and column directions, a plurality of pixels divided by said interconnect lines forming up an array on the dielectric substrate, each of the pixels including therein a driving circuit having therein at least one transistor connected to the interconnect lines, a plurality of dielectric films that covers said driving circuit, and a luminescence element driven by the driving circuit formed on the dielectric substrate and the luminescence element being laid out in the manner that the driving circuit and the luminescence element are not overlapped each other within an effective pixel area when viewed in a direction normal to the dielectric substrate, wherein at least one of dielectric films amongst said plurality of dielectric films formed above said interconnect lines connected to transistor have a light blocking structure having a function of preventing transmission of light inside the dielectric film in which said light blocking structure is built by reflecting or attenuating the light.

The present invention provides, in a second aspect thereof, a method for fabricating a luminescence display apparatus having a plurality of pixels arranged in a matrix where pixels are divided each other with a plurality of interconnect lines extending in row and column directions of the array, including the steps of forming a driving circuit overlying a dielectric substrate in each of the pixels, forming a plurality of dielectric films above the driving circuit, forming a light blocking structure received in at least one of dielectric films amongst said plurality of dielectric films formed above said interconnect lines connected to transistor outside an area of the driving circuit as viewed in a direction normal to the dielectric substrate, the light blocking structure preventing transmission of light inside the dielectric film, and forming a luminescence element being laid out in the manner that the driving circuit and the luminescence element are not overlapped each other within an effective pixel area when viewed in a direction normal to the dielectric substrate.

In accordance with the present invention, the light emitted from the EL device in its own structure and reflected on the substrate or the interlayer film can be attenuated before reaching the TFT by using the light blocking structure. Accordingly, the photo leakage of the TFT due to the self-emitted light can be reduced to provide the active matrix organic EL display apparatus having the less defects and the excellent gradation controllability.

The above and other objects, features and advantages of the present invention will be more apparent from the following description.

### BRIEF DESCRIPTION OF DRAWINGS

FIGS. 1(a) and (b) are top plan views showing configurations of general active matrix organic EL display apparatuses.

FIG. 2 is a top plan view showing a structure of a conventional active matrix organic EL display apparatus.

FIG. 3 is a vertical sectional view taken along a line A-A′ of FIG. 2.

FIG. 4 is a vertical sectional view showing a light blocking structure in the conventional active matrix organic EL display apparatus.

FIG. 5 is a vertical sectional view showing propagation modes of self-emitted light in the conventional active matrix organic EL display apparatus.

FIG. 6 is a top plan view showing a part of an active matrix organic EL display apparatus in accordance with a first Embodiment of the present invention.

FIG. 7 is a vertical sectional view taken along a line B-B′ of FIG. 6.

FIG. 8 is a top plan view showing a part of an active matrix organic EL display apparatus in accordance with a second Embodiment of the present invention.

FIG. 9 is a vertical sectional view taken along a line C-C′ of FIG. 8.

FIG. 10 is a top plan view showing a part of an active matrix organic EL display apparatus in accordance with a third Embodiment of the present invention.

FIG. 11 is a vertical sectional view taken along a line D-D′ of FIG. 10.

FIG. 12 is a top plan view showing a part of an active matrix organic EL display apparatus in accordance with a fourth Embodiment of the present invention.

FIG. 13 is a vertical sectional view taken along a line E-E′ of FIG. 12.

FIG. 14 is a vertical sectional view showing a part of an active matrix organic EL display apparatus in accordance with a fifth Embodiment of the present invention.

FIG. 15 is a top plan view showing a part of an active matrix organic EL display apparatus in accordance with a sixth embodiment of the present invention.

FIG. 16 is a vertical sectional view taken along a line F-F′ of FIG. 15.

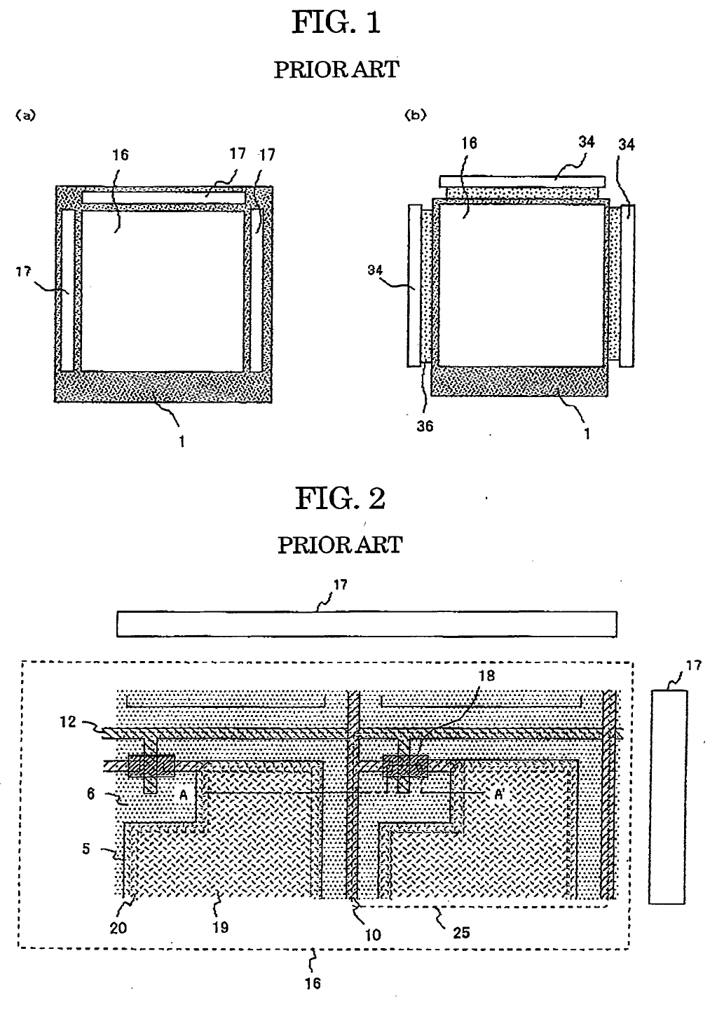

### BEST MODE FOR IMPLEMENTING INVENTION

The EL device of the present invention is preferably made of a material having a refraction coefficient different from that of at least one of the dielectric layers and preferably disposed downward through the dielectric layer. The side surface of the EL device may be nearly perpendicular or inversely tapered with respect to the top surface of the dielectric substrate.

The light blocking structure may be disposed in the shape of a belt on at least a part of a periphery of the luminescent section to surround the luminescent section, or disposed in the shape of a belt on at least a part of a periphery of the transistor configuring the pixel-driving circuit to surround the luminescent section.

A conventional light blocking layer may be positioned under the transistor included in the pixel driving circuit and/or under the transistor included in the circuit of the peripheral circuit region.

The luminescent section is preferably configured by the organic EL device.

In one preferred aspect of the present invention, a luminescence display apparatus is provided as follows. The display apparatus includes a display region formed by a plurality of unit pixels, each disposed in a region surrounded by a plurality of gate lines and data lines extending and crossed in orthogonal direction with each other (row and column direction) overlying a dielectric substrate. The unit pixel includes a pixel driving TFT having one or more transistors, a plurality of interlayer films on the pixel driving TFT, and an EL device formed by a cathode, an EL organic layer and an anode sequentially stacked. The pixel-driving TFT and the EL device are laid out in the manner that the TFT and EL device are not overlapped each other within a pixel area when viewed in a direction normal to the substrate.

### EMBODIMENTS

Although the luminescence display apparatus and a method of fabricating the same in accordance with the present invention will be hereinafter described more specifically by showing Embodiments, the present invention is not restricted thereto.

### First Embodiment

As shown in FIG. 6, an active matrix organic EL display apparatus includes a plurality of gate lines 12 and data lines 10 extending and crossed in orthogonal direction with each other, and pixel driving TFTs 18 are formed on each of the intersecting points. While one pixel driving TFT 18 is shown in FIG. 6, a plurality of the pixel driving TFTs may be used depending on the drive system. The drain terminal, the source terminal and the gate terminal of the pixel driving TFT 18 are connected to the data line 10, a cathode 5 and the gate line 12, respectively.

The planerizing layer 6 flattens irregularities generated due to the difference of the heights of the respective elements such as the gate line 12, the data line 10, the pixel driving TFT 18 and the cathode 5, and has an aperture area to expose the top surface of the cathode 5. An EL organic layer 7 and an anode 8 are stacked on the planerizing layer 6 to form an EL element 19 inside the border 20 with the planerizing layer 6. A light blocking structure 22 of the present Embodiment is formed around the EL element 19 for separating the pixel driving TFT 18 from the EL element 19.

A pixel 25 consists of the gate line 12, the data line 10, the pixel driving TFT 18 and the EL element 19. The pixels 25 are laid out in the form of an array, forming up a display region 16. Peripheral circuit regions 17 consisting of TFTs with an active layer on the same dielectric substrate 1 are laid out on the outer periphery of the display region 16.

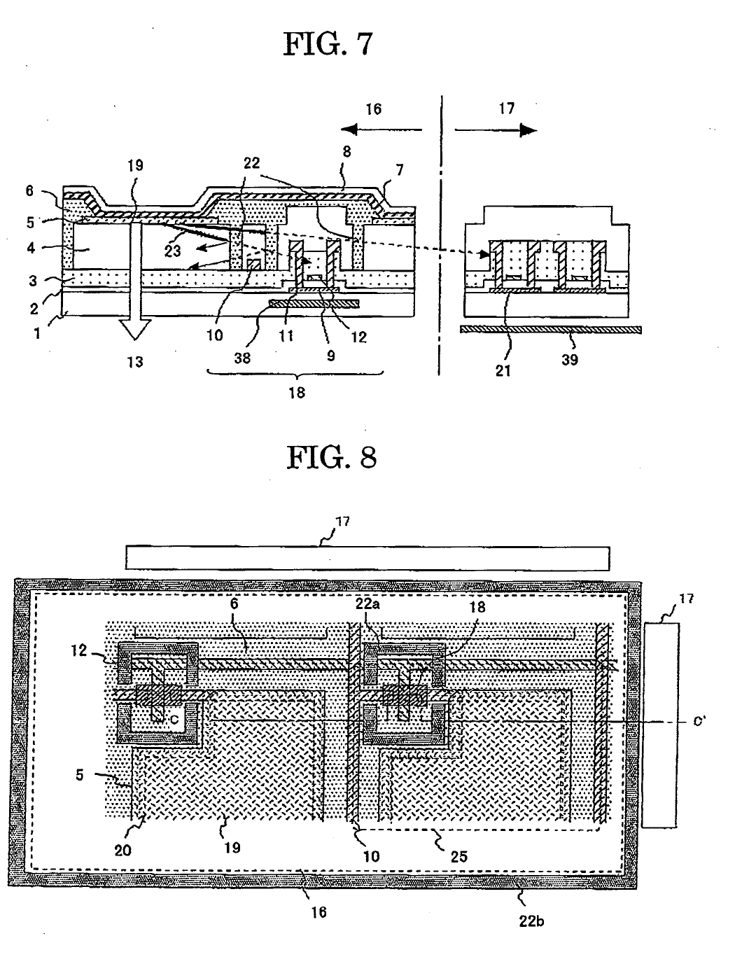

As shown in FIG. 7, the active matrix organic EL display apparatus includes a TFT active layer 9 on the transparent substrate 1 such as glass, and the gate lines 12 are formed thereon through a gate oxide film 2. A first interlayer film 3 is formed to cover the gate lines 12, and a wired layer is formed on the first interlayer film 3. A wiring 11 is connected to the source/drain region of the TFT active layer 9 through a contact hole. A second interlayer film 4 is formed on the wiring 11, and the cathode 5 is formed on the second interlayer film 4. The cathode 5 is connected through a contact hole to the wiring 11 which is connected to the pixel driving TFT 18. A light blocking structure 38 is positioned right under the pixel driving TFT for shielding the pixel driving TFT 18 from external light.

The planerizing layer 6 is formed on the cathode 5 to absorb a step of the cathode 5 and an irregularity formed on the top of the pixel driving TFT 18. The planerizing layer 6 has an aperture to expose the top surface of the cathode 5, and the EL organic layer 7 and the anode 8 are deposited sequentially thereon to form the EL element 19.

The light blocking structure 22 is formed for separating the pixel driving TFT 18 from the EL element 19.

Then, a method of fabricating the active matrix organic EL luminescence display apparatus of the present Embodiment will be described.

After a silicon layer is formed on the transparent substrate 1 such as glass by using the CVD method, isolation is conducted. Then, impurity ions are implanted to determine the conduction type, and metal acting as a gate electrode 2 is deposited by using the sputtering method. Thereafter, gate electrode 2 is formed to complete TFT. The dry etching is generally used for the isolation and the pattering of the gate electrode. The above method of forming the TFT is applicable for a-Si TFT, and when a polysilicon TFT is used instead thereof, an additional process of re-crystallization by means of heat annealing or laser annealing is required after the formation of the silicon layer.

After the TFT formation, the first interlayer film 3 is deposited. Then, contact holes are formed at specified positions by using the dry etching. After a metal film acting as data line 12 is deposited by using the sputtering, the patterning is conducted by the dry etching to form wiring 11. Then, the second interlayer film 4 is formed on the wiring 11 by using the CVD method.

Two methods are applicable for preparing the light blocking structure 22. In accordance with a first method, after the formation of the cathode 5, a portion of the second interlayer film 4 where the light blocking structure 22 is to be laid out is removed to make a vertical trench therein, and the material used for planerizing layer 6 is applied to fill the trench. In this method, an additional step is required to remove the portion of the second interlayer film 4 to form the trench for the light blocking structure 22 though, there is no risk that the material used for cathode 5 is left inside the trench since cathode 5 is formed before the formation of light blocking structure 22.

In accordance with a second method, a portion of the second interlayer film 4 where the light blocking structure 22 is to be laid out is removed to make a vertical trench therein simultaneously with the formation of the contact holes for connecting the cathode 5 and the wiring 11. After the completion of the patterning of the cathode 5, the planerizing layer 6 is applied to fill the trench with the material used for planerizing layer 6. In this method, though there is risk of the material of cathode 5 being left inside the trench after the patterning of the cathode 5, the number of the fabrication steps is not increased because the second interlayer film 4 is removed simultaneously with the formation of the contact holes for connecting the cathode 5 and the wiring 11, hence more preferable than the first method.

After the aperture is patterned in the planerizing layer 6, an annealing is conducted for reflowing the edge of the aperture and for planerizing the region where the pixel driving TFT 18 and the light blocking structure 22 are formed, and then the EL organic layer 7 and the anode 8 are deposited, thereby accomplishing the active matrix organic EL display apparatus.

Then, the configuration and the performance of the light blocking structure 22 will be described. The light blocking structure 22 has the structure in which the said trench is formed perforating through the second interlayer film 4 in the direction normal to the substrate 1 by removing a part of the second interlayer film 4 and is filled with the material comprising the planerizing layer 6. When the refraction coefficient of the second interlayer film 4 and the planerizing layer 6 differ from each other, a plane having a reflection coefficient larger than 0 is formed at the interface. The plane attenuates the light transmitting inside the second interlayer film 4 which may reach the TFT after a plurality of reflection. The combination of the materials of the second interlayer film 4 and the planerizing layer 6 is arbitrary so long as the method of fabrication permits. The combination having larger difference of the refractive coefficients is preferable to increase the attenuating effect. In addition to that, if the light-absorption coefficient of the material of the planerizing layer 6 filled in the trench of the second interlayer film 4 is sufficiently large, the attenuating effect by the absorption can also be noticeable.

As the light blocking structure 22 runs through the second interlayer film 4 in the direction normal to the display apparatus such that the light blocking structure 22 surrounds the EL element 19 and separates the pixel driving TFT 18 from the EL element 19. The light traveling inside the second interlayer 23 emitted from the EL element 19 is reflected partly at the boundary of the light blocking structure 22 and is absorbed partly by the material thereof before reaching the pixel driving TFT 18 so that the intensity of the light traveling inside the second interlayer 23 can be reduced, thereby decreasing the photo leakage current.

Since the light blocking structure 22 is provided in each of the pixels, the light traveling inside the second interlayer 23 must pass through the light blocking structure 22 at least once before reaching the peripheral circuit region 17. Accordingly, the intensity of the light traveling inside the second interlayer 23 reaching the peripheral circuit region 17 can be also reduced.

As described above, the structure can be provided in which the pixel defects and the reduction of contrast ratio due to the TFT mal-function caused by photo leakage current can be minimized, which are the object of the present invention, by reducing the intensity of the light reaching the TFT after the reflection at the interface of interlayer film positioned beneath the EL element 19 to decrease the photo leakage current of the TFT.

### Second Embodiment

The present Embodiment is an improvement of the first Embodiment, and the description of the same components as those of the first Embodiment will be omitted by attaching the same numerals thereto.

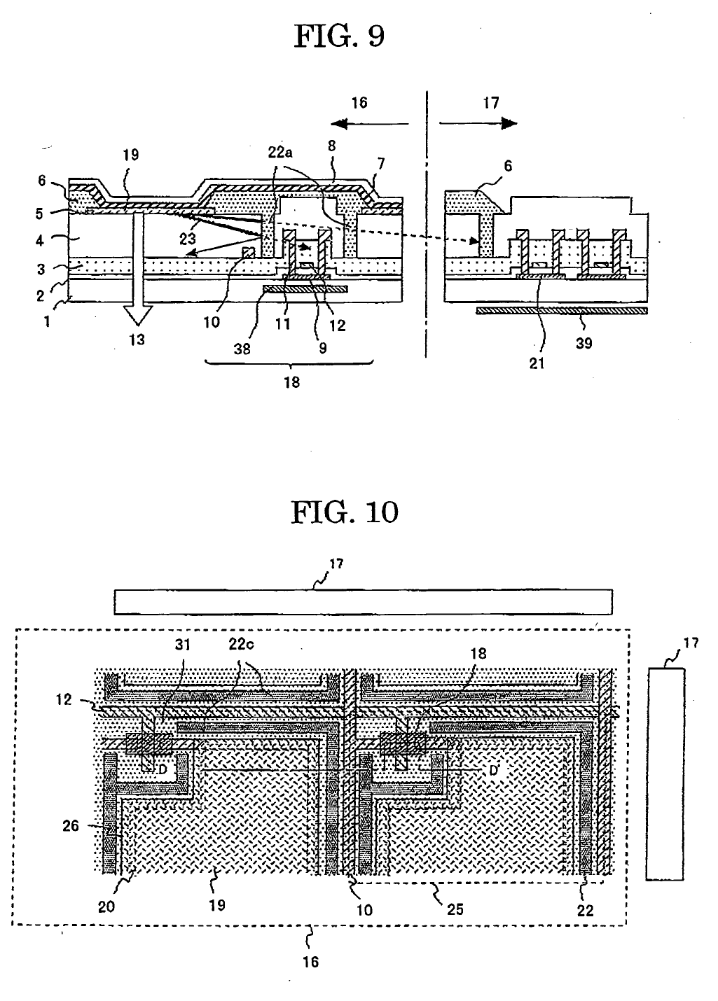

As shown in FIGS. 8 and 9, different from the first Embodiment, a light blocking structure 22a is formed around the EL element 19 to separate the pixel driving TFT 18 from the EL element 19, and another light blocking structure 22b is formed around the display region 16 to separate the display region 16 from the peripheral circuit regions 17.

The light traveling inside the second interlayer 23 emitted from the EL element 19 is reflected partly at the boundary of the light blocking structure 22 and is absorbed partly by the material thereof before reaching the pixel driving TFT 18 so that the intensity of the light traveling inside the second interlayer 23 can be reduced, thereby decreasing the photo leakage current.

Since the light blocking structure 22b is disposed around the display region 16 and separates the display region 16 from the peripheral circuit regions 17, the light 23 traveling inside the second interlayer must pass through the light blocking structure 22b at least once before reaching the peripheral circuit region 17. Accordingly, an amount of the hovering light 23 reaching the peripheral circuit region 17 can be also reduced.

### Third Embodiment

As shown in FIG. 10, an active matrix organic EL display apparatus of the present Embodiment includes a plurality of gate lines 12 made of a metal or a compound such as WSi, Cr and Al and data lines 10 made of Al extending and crossed in orthogonal direction with each other, and pixels 25 are formed on each of the intersecting points. The pixels 25 are laid out in the form of an array, forming up a display region 16 in its entirety. Peripheral circuit regions 17 consisting of TFTs with an active layer are disposed on the outer periphery of the display region 16 on the same dielectric substrate 1.

Each of the pixels 25 includes an EL element 19 and a pixel driving TFT 18 having a polycrystalline Si semiconductor film acting as an active layer for driving the EL element 19. An amorphous Si semiconductor film can be used in place of the polycrystalline Si semiconductor film. The drain terminal, the source terminal and the gate terminal of the pixel driving TFT 18 are connected to the data line 10, an ITO cathode 26 and the gate line 12, respectively. While one pixel driving TFT 18 is shown in FIG. 10, a plurality of the pixel driving TFTs can be used depending on the drive system.

A planerizing layer 31 disposed on the top to absorb the step of the ITO cathode 26 and irregularities generated on the pixel driving TFT 18. The planerizing layer 31 has an aperture area to expose the top surface of the ITO cathode 26 to form the EL element 19 in the region inside of the border 20 with the planerizing layer 31. A light blocking structure 22c is formed around the EL element 19 for separating the pixel driving TFT 18 from the EL element 19.

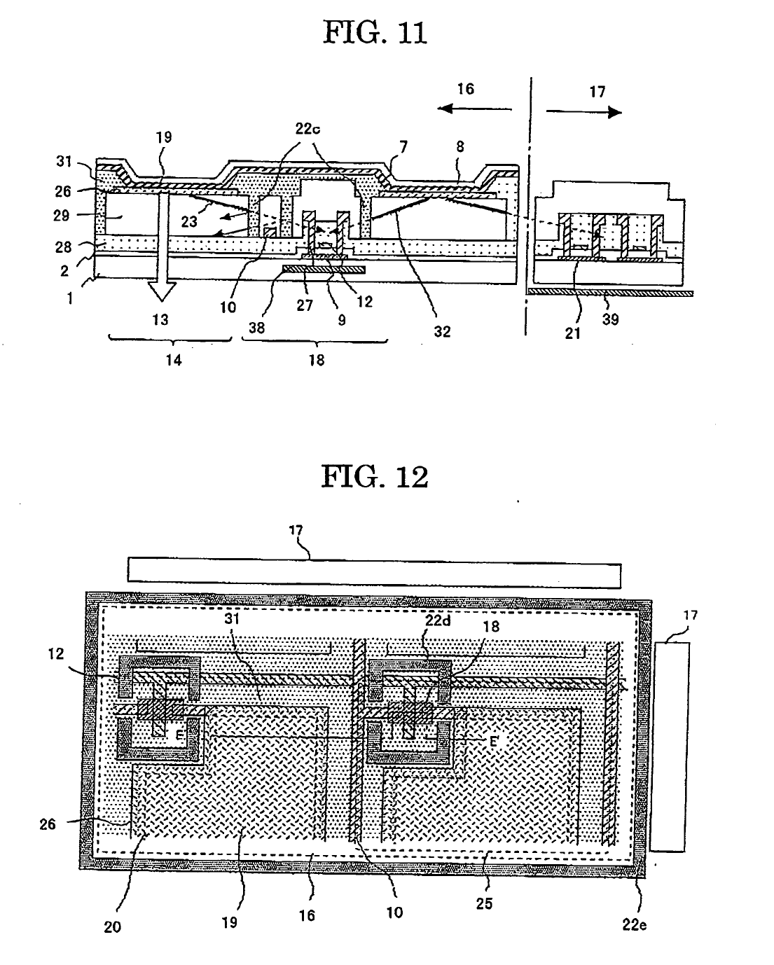

As shown in FIG. 11, the active matrix organic EL display apparatus includes a TFT active layer 9 made of an amorphous Si semiconductor film on the transparent substrate 1 such as glass, and the gate lines 12 are formed thereon through a gate oxide film 2. In the present Embodiment, the gate line can be made of a metal or a compound such as WSi, Cr and Al. An SiO₂ interlayer film 28 is formed to cover the gate lines 12, and the gate line 10 and an Al wiring 27 are formed on the SiO₂ interlayer film 28. The Al wiring 27 is connected to the source/drain region of the TFT active layer 9 through a contact hole. In the present Embodiment, a bottom light blocking structure 38 for shielding the pixel driving TFT 18 from external light is positioned right under the pixel driving TFT 18. The bottom light blocking structure 38 is used for shielding the TFT from external light generally in the field of TFT-applied products, and can be made of a metal or a compound such as WSi, Cr and Al.

A SiN interlayer film 29 is formed on the data line 10 and the Al wiring 27, and the ITO cathode 26 is formed thereon. The ITO cathode 26 is connected through a contact hole to the Al wiring 27. The TFT substrate herein refers to a part which is above the substrate 1 and below the ITO cathode 26, for the sake of simplicity.

Thicknesses of the interlayer films configuring the TFT substrate are arbitrary depending on the transmittances and the insulating performances of the films so long as the method of fabrication permits. In the present Embodiment, while the thicknesses of the gate oxide film 2, the SiO₂ interlayer film 28 and the SiN interlayer film 29 are adjusted to be 100 nm, 400 nm and 800 nm, respectively, these are preferably in the ranges of 30 to 150 nm, 200 to 1000 nm and 200 to 1200 nm in this turn.

A planerizing layer 31 formed on the TFT substrate surrounds the ITO cathode 26 to absorb the step of the ITO cathode 26 and the irregularity formed on the top of the pixel driving TFT 18. A thickness of the planerizing layer 31 is arbitrarily determined depending on the performances of absorbing the irregularity and diminishing the step of the ITO cathode 26 so long as the method of fabrication permits. In the present Embodiment, while the thickness is adjusted to be 1000 nm, it is preferably in the range of about 500 to 1500 nm.

The EL organic layer 7 and the anode 8 are formed on the planerizing layer 31 to form a junction with the ITO cathode 26 in the aperture area of the planerizing layer 31 to provide the device 19. The EL organic layer 7 consists of a first hole-transporting layer, a second hole-transporting layer, a luminescence layer and an electron-transporting layer, and the anode 8 consists of a single layer structure made of silver-magnesium alloy or a two-layer structure such as aluminum+aluminum-lithium alloy and aluminum+lithium fluoride. The light emitted on the EL element 19 is externally introduced from a light-extracting section 14 in the form of extracted light 13. Images are displayed on the lower part of the drawing.

The light blocking structure 22c of the present Embodiment is formed around the EL element 19.

Then, a method of fabricating the active matrix organic EL luminescence display apparatus of the present Embodiment will be described referring to FIG. 11. After a non-crystalline Si semiconductor layer is accumulated on the transparent substrate 1 such as glass by using the CVD method and the poly-crystallization is conducted by using excimer laser annealing or heat annealing, element separation is conducted. The dry etching is generally used for the element separation. After the element separation, the gate oxide film 2 is formed by using the CVD method. After the metal or the compound such as WSi, Cr and Al acting as the gate line 12 is accumulated by using the sputtering method, the patterning is conducted by using the dry etching.

After the gate line 12 formation, the SiO₂ interlayer film 28 is grown. Then, contact holes are perforated at specified positions by using the dry etching. After the data lines 10 and Al acting as the wiring 27 are grown by using the sputtering, the patterning is conducted by the dry etching. Then, the SiN interlayer film 29 is formed.

Thereafter, a contact hole for connecting the ITO cathode 26 with the Al wiring 27 is perforated at a specified position simultaneously with the removal of a portion in the SiN interlayer film 29 which will act as the light blocking structure 22c. The dry etching is used in this step. After the formation of the ITO layer by using the sputtering, the ITO cathode 26 is patterned by the dry etching.

Upon the completion of the TFT substrate, the planerizing layer 31 is formed by spin coating. In the present Embodiment, photoresist generally used in photolithography in the fabrication of a semiconductor integrated circuit is used as a material of the planerizing layer 31. After the aperture area is patterned by using the photolithography upon the application of the planerizing layer 31, annealing is conducted for reflowing the edge of the aperture area and for flattening the irregularities. Finally, the EL organic layer 7 and the anode 8 are accumulated by using the evaporation method to form the EL element, thereby accomplishing the active matrix organic EL display apparatus.

Then, the configuration and the performance of the light blocking structure 22c of the present Embodiment will be described. The light blocking structure 22c has the structure in which the trench is formed perforating through the SiN interlayer film 29 in the direction normal to the substrate 1 by removing a part of the SiN interlayer film 29 and is filled with the material comprising the planerizing layer 31. Since the refraction coefficients of the SiN interlayer film 29 and the photoresist of the planerizing layer 31 are different from each other, a plane having a reflection coefficient larger than 0 is formed at the interface. The plane attenuates the light transmitting inside the SiN interlayer film 29 which may reach the TFT after a plurality of reflection.

The material of the planerizing layer 31 is arbitrary so long as the method of fabrication permits, the material can absorb the step of the ITO cathode 26 and the irregularity generated on the pixel driving TFT 18 for preventing the disconnection deficiency between the EL, and the material has a refraction coefficient different from that of the SiN interlayer film 29. In addition, the difference between the refraction coefficients is preferably larger. For example, a polyimide-applied film and TEOS-based SiO₂ prepared by APCVD are usable in view of the ability of absorbing the step and the irregularity and of the difference of the refraction coefficient from the SiN interlayer film 29.

If the light-absorption coefficient of the material of the planerizing layer 31 is larger, the attenuating effect by the absorption can be also obtained. Since the photoresist material used in the present Embodiment is usually colored to absorb the light, the effect of the attenuation by the reflection at the interface and the effect of the light absorption by the photoresist material can be obtained.

The light blocking structure 22c is disposed downward through the SiN interlayer film 29 in the direction of the normal line of the display apparatus for separating the pixel driving TFT 18 from the EL element 19. The light traveling inside the SiN interlayer film 29 emitted from the EL element 19 is reflected partly at the boundary of the light blocking structure 22c and is absorbed partly by the material thereof before reaching the pixel driving TFT 18 so that the intensity of the light traveling inside the second interlayer 23 can be reduced, thereby decreasing the photo leakage current.

Since the light blocking structure 22c is disposed in each of the pixels embracing the EL element 19, the hovering light 23 is attenuated before reaching the pixel driving TFT 18. Because of the same reason, the hovering light 23 and the reflected light from the adjacent pixel must pass through the light blocking structure 22c at least once before reaching the peripheral circuit region 17. Accordingly, an amount of the hovering light 23 reaching the peripheral circuit region 17 can be also reduced, thereby decreasing the photo leakage current.

Collaterally, when the external light from the substrate reaching the TFT substrate having a certain angle with respect to the normal line reaches into the SiN interlayer film 29 to generate reflected light which propagates in a lateral direction, the external light can be attenuated by the light blocking structure 22c to minimize the leakage current generated in TFT, that cannot be attained by structures for shielding external light described in JP-A-9(1997)-80476, JP-A-11(1999)-84363 and JP-A-2000-164875.

### Fourth Embodiment

The present Embodiment is an improvement of the third Embodiment, and the description of the same components as those of the third Embodiment will be omitted by attaching the same numerals thereto.

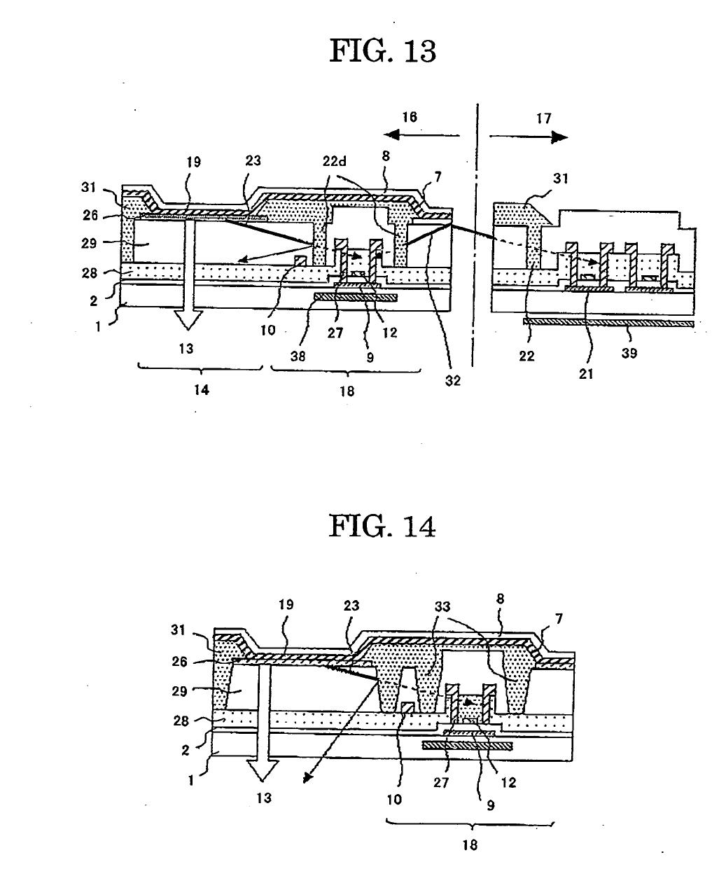

As shown in FIGS. 12 and 13, different from the third Embodiment, a light blocking structure 22d is formed around the pixel driving TFT 18 in a three-dimensional manner to separate the pixel driving TFT 18 from the EL element 19, and another light blocking structure 22e is disposed around the display region 16 to separate the display region 16 from the peripheral circuit regions 17.

The light traveling inside the SiN interlayer film 29 emitted from the EL element 19 is reflected partly at the boundary of the light blocking structure 22d and is absorbed partly by the material thereof before reaching the pixel driving TFT 18 so that the intensity of the light traveling inside the second interlayer 23 can be reduced, thereby decreasing the photo leakage current.

Since the light blocking structure 22e is disposed around the display region 16, the hovering light 23 must pass through the light blocking structure 22e at least once before reaching the peripheral circuit region 17. Accordingly, an amount of the hovering light 23 reaching the peripheral circuit region 17 can be also reduced, thereby decreasing the photo leakage current.

### Fifth Embodiment

The present Embodiment is an improvement of the third Embodiment, and the description of the same components as those of the third Embodiment will be omitted by attaching the same numerals thereto.

As shown in FIG. 14, a light blocking structure 22f becoming thinner from the top to bottom of the present Embodiment is disposed to embrace the EL element 19.

The active matrix organic EL display apparatus can be fabricated by the same procedures as those of the third Embodiment except that a region where the light blocking structure 22f is to be disposed is removed such that a vertical trench having a diameter downward reduced.

The light blocking structure 22f has the diameter downward reduced and its interface is inclined opposing to the light-extracting section 14. Accordingly, a part of the light traveling inside the second interlayer 23 is reflected toward the light-extracting section 14 and externally extracted to increase an external quantum efficiency of the display apparatus.

### Sixth Embodiment

The present Embodiment is an improvement of the third Embodiment, and the description of the same components as those of the third Embodiment will be omitted by attaching the same numerals thereto.

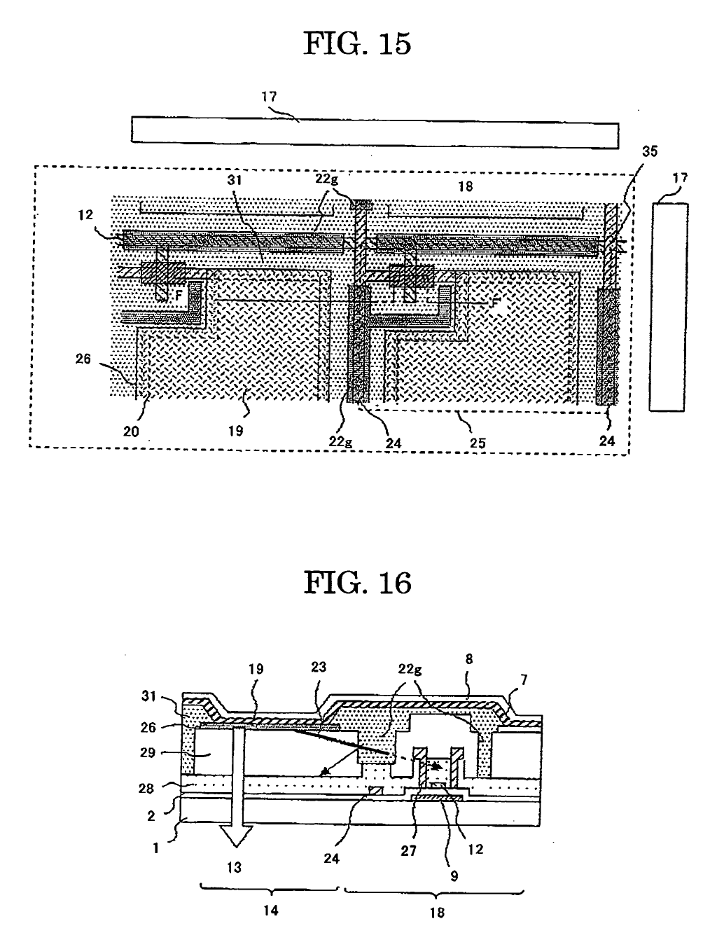

As shown in FIGS. 15 and 16, an active matrix organic EL display apparatus of the present Embodiment includes a plurality of gate lines 12 and data lines 24 partially extending in orthogonal direction with each other except for the intersecting points. The data lines 24 are made of the same material as that of the gate lines 12, and are connected with the gate lines 12 at each of their intersecting points by using bridging wires 35 made of Al.

A light blocking structure 22g is formed around the EL element 19 to be overlapped with the gate lines 12 and the data lines 24.

The active matrix organic EL display apparatus includes a TFT active layer 9 made of a poly-crystalline Si semiconductor film on the transparent substrate 1 such as glass, and the data lines 24 and the gate lines 12 are formed thereon through a gate oxide film 2. The data line 24 and the gate line 10 can be made of a metal or a compound such as WSi, Cr and Al. The data lines 24 extend from the near side to the back side of the drawing, are cut at the intersecting points with the gate lines 12 and are jumper-connected by using the bridge wirings 35.

An SiO₂ interlayer film 28 is formed on the data line 24 and the gate lines 12, and the Al wiring 27 is formed on the SiO₂ interlayer film 28. The Al wiring 27 is connected to the drain/source region of the TFT active layer 9 through a contact hole.

The SiN interlayer film 29 is formed on the data lines 24 and the Al wiring 27, and the ITO cathode 26 formed thereon is connected to the Al wiring 27 through a contact hole.

The active matrix organic EL display apparatus of the present Embodiment can be fabricated similarly to the third Embodiment.

In the third Embodiment, the light blocking structure 22c is disposed to be not overlapped with the data lines 10 so that an aperture ratio which is an area of the EL element occupying in the pixel 25 is reduced. The part of the SiN interlayer film is required to be removed for forming the light blocking structure. If the light blocking structure 22c is overlapped with data lines 10 in the configuration of the third Embodiment, the reliability may be reduced because no SiN interlayer film 29 is present for covering the data lines 10.

On the other hand, in the present Embodiment, because the data lines 24 and the gate lines 12 are formed in the same layer and are protected by the SiO₂ interlayer film, no reliability problem arises when the light blocking structure 22g is overlapped with the data lines 24. The above configuration enables the area occupied for forming the light blocking structure 22g to be minimum, thereby suppressing the reduction of the aperture ratio of the pixel 25 due to the formation of the light blocking structure 22g to the minimum.

In the configuration, the formation of the data line 24 and the gate line 12 in the same layer increases the distance between the data line 24 and the anode 8 and replaces the SiN interlayer film 29 with the photoresist having a lower dielectric constant. Thereby, a parasitic capacitance generated between the data line 24 and the anode 8 is collaterally reduced because the dielectric constant of the component sandwiched by the data line 24 and the anode 8 is decreased.

Collaterally, when the external light reaching the TFT substrate from the light extracting section 14 having a certain angle with respect to the normal line of the substrate reaches into the SiN interlayer film 29 to generate reflected light which propagates in a lateral direction, the external light can be attenuated by the light blocking structure 22g to minimize the leakage current generated in TFT.

### EXAMPLE

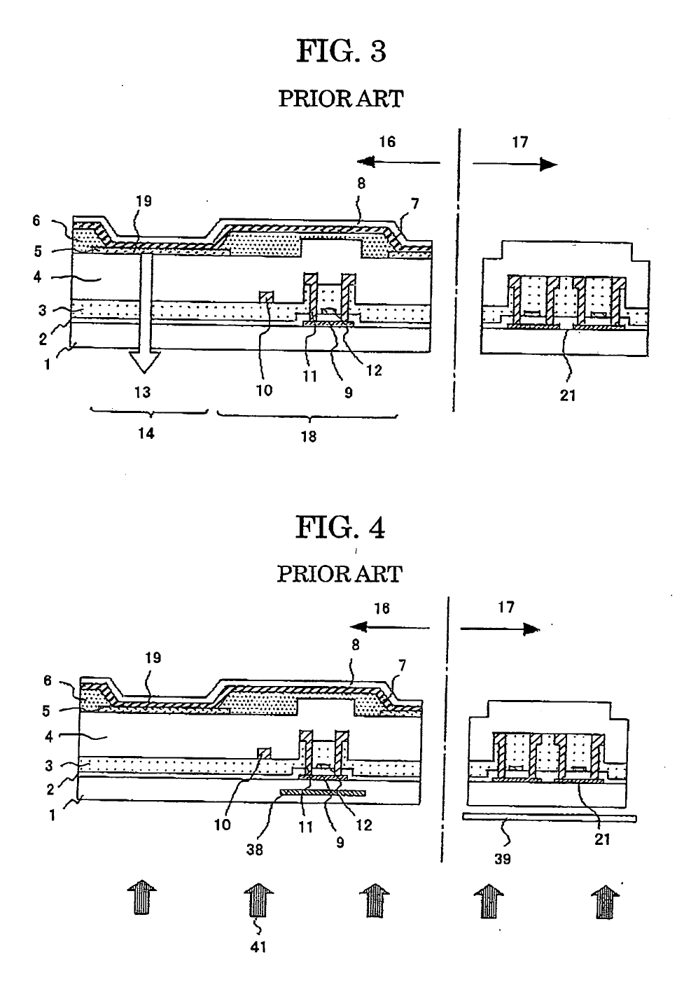

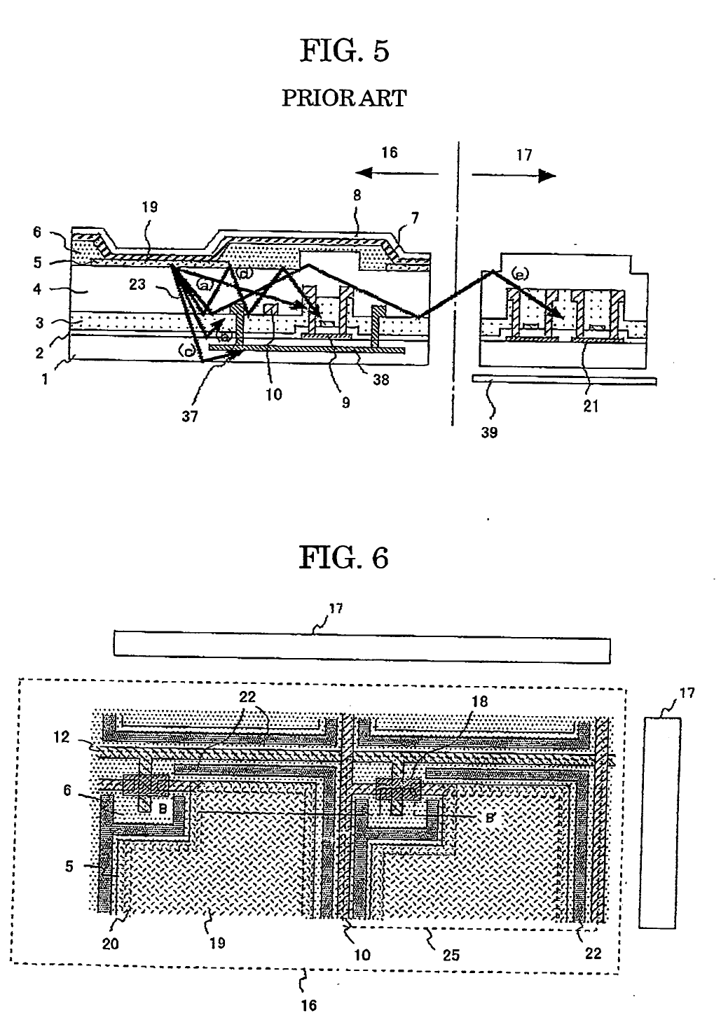

In order to confirm the effect of the light blocking structure, the total sums of the anode currents flowing through the EL elements were measured by using the display apparatus having no light-shielding structure as shown in FIG. 3, the display apparatus having only the bottom light blocking structure 38 as shown in FIG. 4, and the display apparatus of the Embodiment of the present invention having the light blocking structure and the bottom light blocking structure when images are displayed. In accordance with the principle of operation, the current generated by the transistor is decreased to reduce the total sum of the anode current when the leakage current is generated. That is, the larger total sum of the current flowing through the EL element shows the smallness of the light leakage current.

At first, the light-shielding performances against external light of the display apparatus having only the bottom shielding layer 38 exemplified in FIG. 4 and the display apparatus having no light-shielding structure exemplified in FIG. 3 were compared with each other by exposing these apparatuses to the sunlight having an illumination intensity of 6000 lux or more in the open air. As a result, the former generated the anode current larger than that of the latter by 30%.

On the other hand, the light blocking performances against the self-emitted light of the display apparatus having both of the bottom shielding layer 38 and the light blocking structure 22 in accordance with the Embodiment of the present invention exemplified in FIG. 7 and the display apparatus having only the bottom shielding layer 38 exemplified in FIG. 4 were compared with each other by operating both of the display apparatuses in dark place. As a result, the former generated the anode current larger than that of the latter by 10%.

These results revealed that the light blocking structure 22 of the Embodiment had the more excellent light blocking performance against the self-emitted light than the bottom shielding layer 38 exemplified in FIG. 4, and the effect of the light blocking structure 22 of the Embodiment against the self-emitted light approached to one-third that of the bottom shielding layer 38 exemplified in FIG. 4 which was applied to a conventional liquid crystal display apparatus.

Since the above embodiments are described only for examples, the present invention is not limited to the above embodiments and various modifications or alterations can be easily made therefrom by those skilled in the art without departing from the scope of the present invention.

1. A luminescence display apparatus comprising a dielectric substrate, a plurality of pixels arranged in a matrix on said dielectric substrate, and a plurality of interconnect lines extending in row and column directions of said array for isolation of said pixels from one another, each of said pixels including therein a driving circuit having therein a drive transistor connected to said interconnect lines, at least two dielectric film overlying said driving circuit, and a luminescence element driven by said drive circuit and overlying said dielectric film, said luminescence element being laid out in the manner that said driving circuit and said luminescence element are not overlapped each other in an effective pixel area apart from said drive circuit as viewed in a direction normal to said dielectric substrate,
wherein said dielectric film receives therein a shield stripe outside said effective pixel area and having a function of preventing transmission of light therethrough within said dielectric film.

2. The luminescence display apparatus according to claim 1, wherein said shield stripe is made of a substance having a refractive coefficient different from that of said dielectric film.

3. The luminescence display apparatus according to claim 1, wherein a boundary between said dielectric film and said shield stripe is substantially normal to said dielectric substrate.

4. The luminescence display apparatus according to claim 1, wherein said shield stripe substantially surrounds at least a portion of said effective pixel area.

5. The luminescence display apparatus according to claim 4, wherein said shield stripe has a top wider than a bottom of said shield stripe.

6. The luminescence display apparatus according to claim 4, wherein said shield stripe overlaps a portion of said interconnect lines as viewed in said direction.

7. The luminescence display apparatus according to claim 1, wherein said shield stripe substantially surrounds said driving circuit.

8. The luminescence display apparatus according to claim 1, wherein said shield stripe has a substantially flat top surface.

9. The luminescence display apparatus according to claim 1, wherein a shield film is disposed underlying at least said driving circuit or said peripheral area.

10. The luminescence display apparatus according to claim 1, wherein said luminescence display apparatus is an electro-luminescence display apparatus.

11. A method for fabricating a luminescence display apparatus, including a plurality of pixels, comprising the steps of:
forming a driving circuit overlying a dielectric substrate in each of said pixels;
forming at least two dielectric films overlying said driving circuit;
forming a shield stripe received in said dielectric substrate outside an area of said driving circuit as viewed in a direction normal to said dielectric substrate, said shield stripe preventing transmission of light through said dielectric film; and
forming a luminescence element in an effective pixel area of said pixel, said effective pixel area being apart from said driving circuit as viewed in said direction.

12. The method according to claim 11, said stripe pattern forming step includes the steps of forming a trench in said dielectric film, and depositing a substance within said trench, said substance having a refractive coefficient different from that of said dielectric film.

13. The method according to claim 12, wherein said trench forming step forms a through-hole for connecting said luminescence element and said driving circuit.

14. The method according to claim 12, wherein said trench forming step is conducted after forming an anode of said luminescence element, said anode being connected to said driving circuit.

15. The method according to claim 12, wherein said trench forming step forms said trench having a side surface substantially normal to said dielectric substrate.

16. The method according to claim 11, wherein said substance is used as a planarization layer exposing therefrom an anode of said luminescence element.

17. The method according to claim 11, wherein said luminescence element is an electro-luminescence element.
